(19) United States
(12) Patent Application Publication
(10) Pub. No.: US 2004/0098349 A1
(43) Pub. Date: May 20, 2004

(54) Method and apparatus for a portable information account access agent

(76) Inventor: Michael Tolson, Corte Madera, CA (US)

Correspondence Address: Jonathan Alan Quine, Quine Intellectual Property Law Group, P O Box 458, Alameda, CA, 94501, US

(21) Appl. No.: 10/381,524

(22) PCT Filed: Sep. 6, 2001
(86) PCT No.: PCT/US01/28150

(51) Int. Cl. G06F 17/60

(52) U.S. Cl. 705/64

(57) ABSTRACT

A method and/or system (FIG. 4) for providing persistent graphical agent (10) linked to accounts enabling a user to access one or more accounts using a computer system. In specific embodiments, the agent (10) can provide advanced interactive graphics and communications back to a server.

### CROSS REFERENCE TO RELATED APPLICATIONS

This application claims benefit of priority from provisional patent application 60/230,341 filed Sep. 6, 2000, incorporated herein by reference.

This application claims benefit of priority and is a continuation in part of patent application Ser. No. 09/852,971 filed May 8, 2001, incorporated herein by reference.

This application claims benefit of priority and is a continuation in part of patent application Ser. No. 09/852,979 filed May 8, 2001, incorporated herein by reference.

This application claims benefit of priority and is a continuation in part of patent application Ser. No. 09/852,963 filed May 8, 2001, incorporated herein by reference.

### COPYRIGHT NOTICE

Pursuant to 37 C.F.R. 1.71(e), applicant notes that a portion of this disclosure contains material that is subject to copyright protection (such as, but not limited to, source code listings, screen shots, user interfaces, or user instructions, or any other aspects of this submission for which copyright protection is or may be available in any jurisdiction). The copyright owner has no objection to the facsimile reproduction by anyone of the patent document or patent disclosure, as it appears in the Patent and Trademark Office patent file or records, but otherwise reserves all copyright rights whatsoever.

### FIELD OF THE INVENTION

The present invention relates to the field of information and/or data handling methods and systems. In specific embodiments, the present invention involves methods and/or systems directed to facilitating purchase and/or account transactions using distributable active content that can exist in a variety of software environments.

### BACKGROUND OF THE INVENTION

Familiarity with information and data handling methods and techniques is characteristic of practitioners in the art and is presumed of the reader. At the present time, many people are familiar with accessing information over a data network. The WWW is a public data network that is becoming increasingly used for accessing multi-media information. This information can be one-way, passively experienced information, or two-way information including two-way text, audio, or video data.

At the present time, there is a desire to enrich the user experience. One particular aspect of typical WWW interactions is that interactions take place within the confines of an application, such as a browser. In order to access the information, a user must be at a computer system with a particular type of application for user access. Generally, an interactive application is limited to a particular platform, such as a particular operating system or information handling device.

The Internet comprises computers and computer networks that are interconnected through communication links. The interconnected computers exchange information using various services, such as electronic mail, ftp, the World Wide Web (“WWW”), and other services including secure services. The WWW service can be understood as allowing a server computer system (e.g., a Web server or a Web site) to send Web pages of information to a remote client computer system. The remote client computer system can then display the Web pages. Generally, each resource (e.g., computer or Web page) of the WWW is uniquely identifiable by a Uniform Resource Locator (“URL”). To view a specific Web page, a client computer system specifies the URL for that Web page in a request. The request is forwarded to the Web server that supports that Web page. When that Web server receives the request, it sends that Web page to the client computer system. When the client computer system receives that Web page, it typically displays the Web page using a browser. A browser is a special-purpose application program that effects the requesting of Web pages and the displaying of Web pages.

Currently, Web pages are typically defined using a Hyper Text Markup Language (“HTML”) or similar language. HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

The World Wide Web is especially conducive to providing information services over the internet. Services can include items (e.g., music or stock quotes) that are delivered electronically to a purchaser over the Internet. Services can also include handling orders for items (e.g., groceries, books, or chemical or biologic compounds, etc.) that may be delivered through conventional distribution channels (e.g., a common carrier). Services may also include handling orders for items, such as airline or theater reservations, that a purchaser accesses at a later time. A server computer system may provide an electronic version of an interface that lists items or services that are available.

Typically, purchase or ordering transactions for such items occurs through connecting to a website and logging into an account maintained at that website. This can be inconvenient for a user and is at time less familiar that a users non-web purchase experiences.

### SUMMARY

The present invention, in various aspects, involves a method and/or system and/or apparatus for providing an enhanced user interaction in an information processing environment, in particular in situations involving purchases or some other types of transactions using credit and/or debit accounts.

In various specific embodiments, aspects of the invention enable the presentation to users of a portable information agent (PIA) (at times, referred to herein as an Envoii™) which can provide enhanced user interactions with graphical objects. Particular aspects of the invention further comprise systems, components, and/or methods allowing an agent to be portable over different platforms.

In the present discussion, information available over a public network may be referred to as contained in documents or presentations or compositions. It should be understood that the terms information or document refer to any type of digitally-encoded data that can be presented or transmitted by a computer or other digital device including, but not limited to, text, graphics, photos, executable files, data tables, audio, video, three dimensional data, or multimedia data that is a combination of any of these.

In a further embodiment, the invention is enhanced by new methods for allowing an agent supplier to enhance and track user interaction with an agent and for communicating information between an agent supplier and an agent and is further enabled by new methods allowing an agent to be moved from a browser application to a desktop or to another platform. In a further embodiment, the invention can be further enhanced by new methods for tracking and reporting back user interactions with an enhanced agent. In a further embodiment, the invention can be used along with new methods and/or systems allowing an agent to move from an initial application to a new location without requiring specific user input. In a further embodiment, the invention can be used with new methods and/or systems allowing composeability of PIA (or Envoii) objects, by allowing a one Envoii agent to be connected to another Envoii agent, thereby providing additional functions.

In further embodiments, the present invention may be understood in the context of user systems in communication with external data systems over a communication media. An important application for the present invention, and an independent embodiment, is in the field of providing a persistent object that can be initially accessed through a browser and that can move to other software platforms, such as other programs, a desktop, or other devices. In particular embodiments, services according to specific embodiments of the invention can be accessed using an agent over the Internet, optionally using Internet media protocols and formats, such as HTTP, RTTP, XML, HTML, DHTML, VRML, as well as image, audio, or video formats etc. However, using the teachings provided herein, it will be understood by those of skill in the art that the methods and apparatus of the present invention could be advantageously used in other related situations where it is desirable to have a persistent agent.

The invention and various specific aspects and embodiments will be better understood with reference to the following drawings and detailed descriptions. In some of the drawings and detailed descriptions below, the present invention is described in terms of the important independent embodiment of a system operating on a digital data network. This should not be taken to limit the invention, which, using the teachings provided herein, can be applied to other situations, such as cable television networks, wireless networks, etc. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims. Furthermore, it is well known in the art of internet applications and software systems that particular file formats, languages, and underlying methods of operation may vary. The disclosure of a particular implementation language or format of an element should not be taken to limit the invention to that particular implementation unless so provided in the attached claims. The invention will be better understood with reference to the following drawings and detailed description.

Furthermore, it is well known in the art that logic systems and methods such as described herein can include a variety of different components and different functions in a modular fashion. Different embodiments of the invention can include different mixtures of elements and functions and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative or example embodiment in this specification. The functional aspects of the invention that are implemented on a computer, as will be understood from the teachings herein, may be implemented or accomplished using any appropriate implementation environment or programming language, such as C, C++, Pascal, Java, Java-script, HTML, XML, dHTML, assembly or machine code programming, etc. Source code examples used herein are given for example purposes. It will be understood to those of ordinary skill in the art that many different source code examples could be used to implement aspects of the invention. All references, publications, patents, and patent applications cited herein are hereby incorporated by reference in their entirety for all purposes.

### BRIEF DESCRIPTION OF THE DRAWINGS

FIGS. 1A-C illustrates an example display and example of use of a debit and/or credit card Envoii™ (or Virtual Plastic™) according to specific embodiments of the present invention.

FIG. 2 is a flow chart illustrating example methods of using an account interface persistent graphical agent according to specific embodiments of the invention.

FIG. 3 is a flow chart illustrating example methods of using an account interface persistent graphical agent to solicit an account according to specific embodiments of the invention.

FIG. 4 illustrates an example graphical display showing a method of moving an Envoii™ from a browser window to a desktop.

FIG. 5 illustrates an example graphical display showing an example Envoii PIA residing on a desktop after closing a browser window and illustrating that an Envoii PIA has a sustained connection, so that when a client restarts a machine, an Envoii can remain on the desktop where the user left it.

FIG. 6 illustrates an example graphical display showing an Envoii PIA providing active links to two different URLs through launched browser windows.

FIG. 7 illustrates an example graphical display showing an Envoii PIA activating an associated function, such as an email sending program.

FIG. 8 illustrates an example graphical display showing an Envoii PIA being associated with a composable function.

FIG. 9 illustrates an example graphical display showing an Envoii PIA moved to multiple information devices.

FIG. 10 illustrates an example business method according to specific embodiments of the invention wherein a services provider can keep in touch with multiple customers using an Envoii PIA.

FIG. 11 illustrates an architecture of a component oriented system that can be used according to specific embodiments of the invention to enable an account access Envoii™ PIA.

FIG. 12 is a diagram providing additional details regarding the architecture shown in FIG. 11.

FIG. 13 is a block diagram showing a representative example logic device in which various aspects of the present invention may be embodied.

### DESCRIPTION OF SPECIFIC EMBODIMENTS

Embodiment as a Credit or Debit Account Envoii

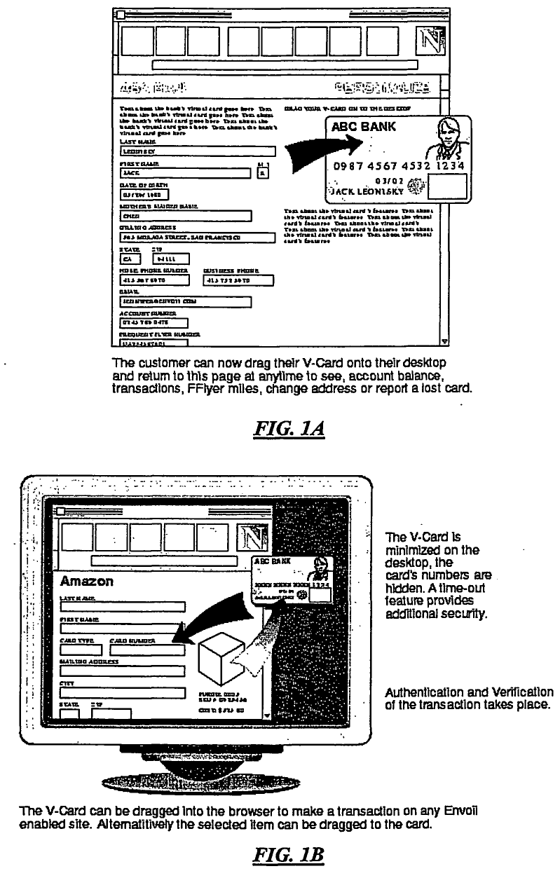

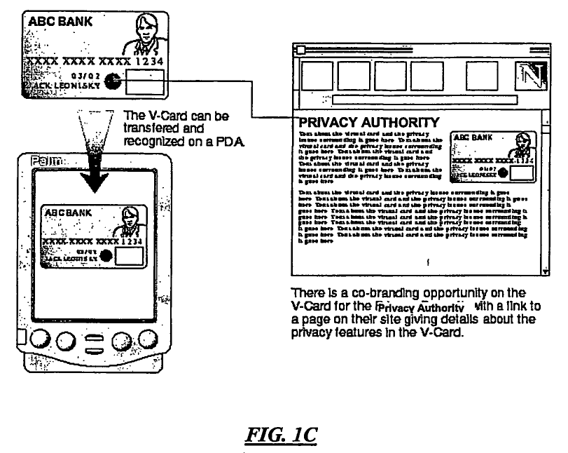

FIGS. 1A-C illustrates an example display and example of use of a debit and/or credit card Envoii™ (or Virtual Plastic™) according to specific embodiments of the present invention. Thus, according to specific embodiments of the present invention, the invention can appear as a graphical representation of a credit card or other account or membership card or can be formatted to resemble a consumer check with access to a checking account. According to specific embodiments of the present invention, such a graphical representation is associated with state, stored data, active content, and communications links, all of which are persistent and portable, as will be further understood from the teachings provided herein. To a user, therefore, the invention provides a graphical object that allows a user to complete a transaction by one or more of: (1) swiping a card envoii over a form or a product; (2) dragging a product or form from a browser onto the card on the desktop to complete a transaction; or any other desired user action enabled by the envoii architecture. For example, a card card envoii can contain active links to a voice recoginition application on an operating system such that a spoke command, such as “Buy with credit card.” will activate the envoii object and cause the object to complete the transaction.

Further Example Embodiment as a Credit Card Envoii

In a further example embodiment, a payment account envoii can be referred to as Virtual Plastic (VP). Virtual Plastic can be understood as a persistent, mobile card. The card, can be obtained from a bank's site, dragged onto the desktop and then used to make transactions where Envoii enabled sites exist. VP can be used on a variety of platforms, such as Mac, PC, Linux, Palm Pilot. etc. VP can be used in variety of application interfaces, such as E-mail, DHTML, Netscape, Internet Explorer, AOL, Desktop, Palm Pilot, etc.

Details of Example Embodiment

Communications issues throughout the lifecycle of a VP according to a particular example embodiments of the invention are discussed below. This example provides numerous exemplary details of operation that are not part of all embodiments.

Birth: Virtual Plastic (VP), according to specific embodiments of the present invention, is composed of a rectangular image with the appearance of a credit card, and optionally containing brands, names, logos. A user can enter personal data, such as name, account number, address, etc., directly into the VP. The data will consist of three strings: the card number, which will have 12 hidden numbers, with the remaining 4 digits visible, the user name and the expiration date. The card can be dragged out of the browser and live on the end user's desktop. At anytime the end user wishes to make a transaction the card can be swiped into an Envoii enabled page or alternatively any item within an Envoii enabled page can be dragged onto the VP.

Desktop Life: On dragging the VP into the browser, a mobile proxy of the VP becomes translucent with the original remaining in place on the desktop. The translucency allows visibility of an Envoii enabled form when making a transaction. The proxy VP is ephemeral. On a key command or right mouse click the end user is able to check account information. As a security measure a dialog box is presented asking the end user to enter their Pin Number; a “Name” field will be filled by default with the VP owner's name. The end user selects an OK button from the dialog box and the page is populated with the individual's Account Balance, their last 10 transactions, with an option to view all their transactions, Frequent Flyer miles accumulated, a lost card option, change of address option and additional shipping addresses.

Thus, a VP in particular embodiments is able to perform three functions:

1. Act as a portal for content

2. Transfer its information to a Palm

3. Transfer its information onto Envoii compliant forms

As a portal for content, the VP has content pushed to the card on either, selection of an icon or logo or on a right mouse click or on a keystroke command, revealing a menu of options. This content may be in the form of an entirely new envoii. For instance, a Chase branded stock ticker could be pushed to the VP and launched. The VP itself will not contain the information to make the stock ticker, but rather receive the description from a server. The user will be able to select preferences on the content that he/she would like to have pushed to the VP.

Similarly, the card can also be dragged over a palm envoii on the desktop to send, either via hotSync or infrared, the VP information and a PalmVPVoy description to the palm. Because this PalmVPVoy will be relatively lightweight, the information for making the card could be placed on the client's machine when the user drags the VP onto the desktop for the first time. The VP could reference NVO/XML/Java description of the card, as well as the necessary components to send to the palm.

VP makes a secure transaction with an Envoii-compliant form. The form itself may be in Envoii or HTML. The ability to interact with HTML widens the applicability of the VP tremendously. With HTML, the card can communicate, either through an intermediary or directly, with the HTML DOM and thereby input data into the HTML form fields. After dropping the card, a confirmation dialog appears to confirm the user's Pin Number.

Security Issues

In particular embodiments, the communication between the forms and a VP is secured. No third parties are able to intervene between the form and card communication. Second, VP has security measures while on the desktop to prevent non-verified users from getting or using the card. VP does not display the credit card number or expiration date while on the desktop. Otherwise, someone other than the owner might use the information. The card is able to verify the user of the VP. Hence, the user will need to have access to their Pin Number to use the VP. The user will be prompted for their Pin Number when trying to make a payment, transaction or when transferring the VP to the palm, or copy the card to another computer. A timeout function will be triggered when the VP is left on the desktop unused. The end user can customize timeout settings. In particular embodiments, VP can be maximized, minimized, docked, opened and closed.

As will be understood from the teachings herein, an active credit card can be implemented according to the specific envoii system discussed herein. In other embodiments, the invention may also be implemented using other appropriate display or encoding systems, such as in native JAVA, COM, or any other programming language.

Method Using VP to Complete a Transaction

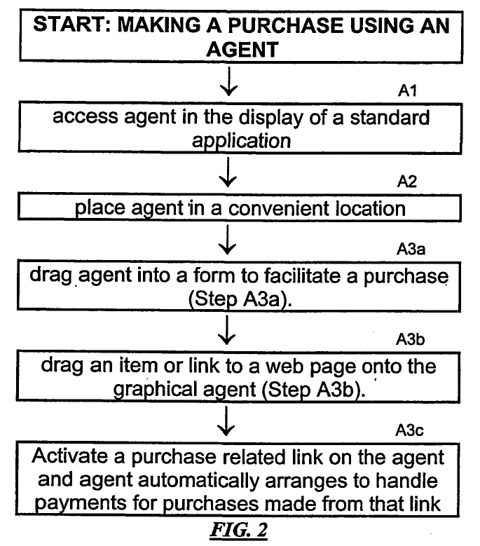

FIG. 2 is a flow chart illustrating example methods of using an account interface persistent graphical agent according to specific embodiments of the invention. In one embodiment, a user first sees an account interface persistent graphical agent in the display of a standard application, such as in a browser window or in an email (Step A1). Depending on the nature of the initial communication, the agent may be a “blank” agent or can be an initiated agent. For a “blank” agent, the user must at some point select the agent and enter relevant data, such as account number and mailing address. An initiated agent may be provided to a user directly from a user's bank or credit card company. In either case, an agent can be provided in an email that is sent to a user or in a web-page that a user accesses.

Once an agent is presented to a user, a user typically will indicate the agent and indicate a new location for the agent that is convenient to the user (Step A2). For example, a user can select an agent in a web browser or email and drag it to the user's desk top or to a PDA.

With the agent residing in a convenient location to a user, the user can use the agent to effect a purchase. This can be done by dragging the agent into a form displayed in a standard browser, such as a “check out” form common in many shopping sites (Step A3a). Alternatively, a user can drag an item or link to a web page form onto the graphical agent (Step A3b). As another alternative, an agent can include a link on it, such as to a travel site or auction site and when that link is activated for the agent, the agent arranges for payments for purchases confirmed from the site (Step A3c).

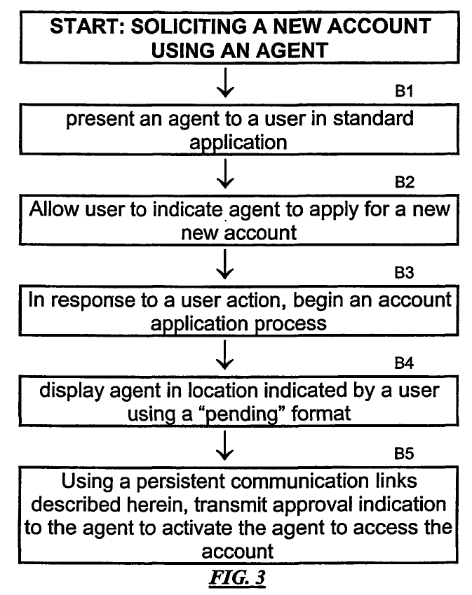

FIG. 3 is a flow chart illustrating example methods of using an account interface persistent graphical agent to solicit an account according to specific embodiments of the invention. In this embodiment, an institution that wishes to solicit new account holders, such as a credit card company or a department store providing a private credit card, can use an account interface persistent graphical agent to accomplish this. Initially, the institution provides an agent in the display of a standard application, such as in a browser window or in an email, that is accessed by a user (Step B 1). Again, in specific embodiments, the agent may be entirely “blank” or partially initiated. If a user wishes to establish a new account, the user can select the agent (Step B2). A user selection or action activates an account application process (Step B3) in which the user is prompted to provide an additional needed information to establish the account. In some cases, activation of the account will require a processing delay. During account processing, the agent can remain on the user's desktop in a “pending” form (Step B4). Using the persistent communication links described herein, the institution can send a status message to the agent when the account is approved or declinet and this information will be automatically displayed by changing the display of the agent (Step B5). Once approved, the agent can be used to complete purchases as described above.

General Envoii User Interaction Methods and Operation

It will be understood from the teachings provided herein to those of skill in the art that the invention as described above can be implemented in various ways be persons of skill in computer programming arts. What follows is a summary description of a particular architecture and/or methods that can be used to implement specific embodiments according to the present invention. This discussion is provided to describe details of preferred embodiments but is not intended to limit the scope of the invention as heretofor described or as provided in the attached claims. The invention has thus far been described in terms of general methods and devices. The previous description is a full and complete description sufficient to allow an ordinary practitioner in the art to make and use the invention as described. It will be understood to those of skill in the art from the teachings provided herein that the described invention can be implemented in a wide variety of specific programming environments and logical systems (such as UNIX, Windows, Solaris, Oracle, etc.) using a wide variety of programming languages (such as SQL, Visual Basic, Pascal, C++, Basic, Java, etc.) and wide variety of file formats.

What follows are descriptions of example systems and methods that embody various aspects of the present invention and that describe further novel aspects of particular embodiments. The following discussion is included, in part, in order to disclose particularly preferred modes presently contemplated for practicing the invention. It is intended, however, that the previous discussion and the claims not be limited by the examples that follow. It is further intended that the attached claims be read broadly in light of the teachings provided herein. Where specific examples are described in detail, no inference should be drawn to exclude other known examples or examples described briefly from the broad description of the invention or the language of the claims. It is therefore intended that the invention not be limited except as provided in the attached claims and equivalents thereof.

According to specific embodiments, the present invention can be used in an programming environment that generally extends and transforms user interactions over the internet by providing portable information agents (PIAs) that can be initially accessed in a first interface or window (such as an HTML browser window or an email message window), but that can move or be moved to another software location, such as a desktop. Once moved to another location, a PIA maintains the majority of the functionality and connections that it had in the initial location.

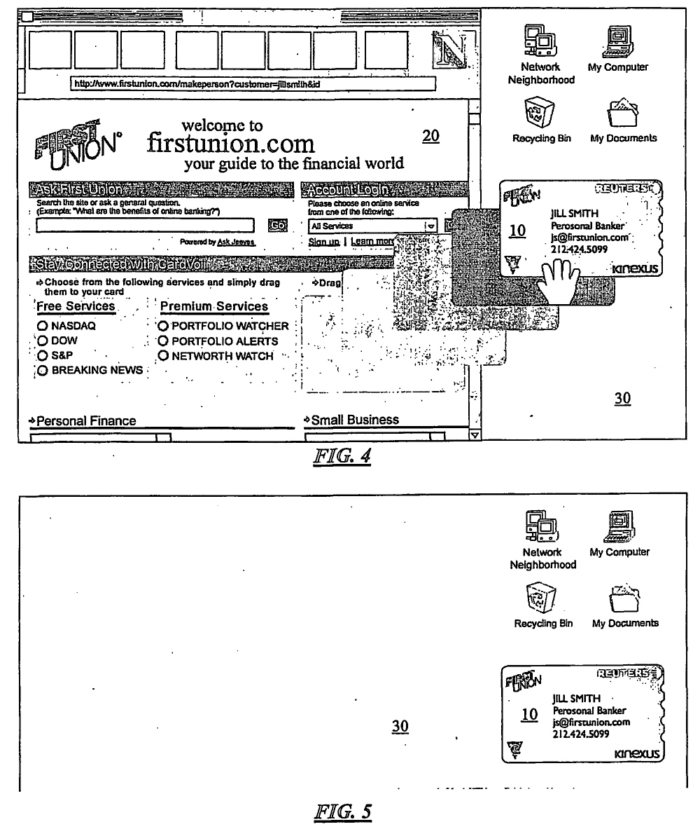

FIG. 4 illustrates an example graphical display showing a method of moving an Envoii™ from a browser window to a desktop. As shown in the figure, an Envoii 10 (in this case displayed as a business card of a bank representative Jill Smith) can be dragged from its initial location 20, which in this example is within a browser window, and can be moved to a new location 30, which in this example is on a desktop, such as a Windows Operating System desktop.

As will be further understood from the discussion below, the technology according to specific embodiments of the invention allows active content to be brought to the desktop without application installations. Envoiis can be dragged from the browser to the desktop or to any Envoii-enabled place. Envoiis can pull data from external sources in response to a user's actions or can be designed to move to a new location without requiring user action.

FIG. 5 illustrates an example graphical display showing an example Envoii PIA residing on a desktop after closing a browser window and illustrating that an Envoii PIA has a sustained connection, so that when a client restarts a machine, an Envoii can remain on the desktop where the user left it. According to specific embodiments of the invention, Envoiis can exist independent of the browser and other applications and can freely travel from place to place and the experiences and functionalities found within Envoiis migrate from place to place without fragmentation. Thus, in this example, when Jill's clients restart their machines, her card appears on their desktops, just as they left it. Likewise, a VP envoii retains connections to its account so that a user can easily access account information or can easily use the desktop envoii to complete a new transaction.

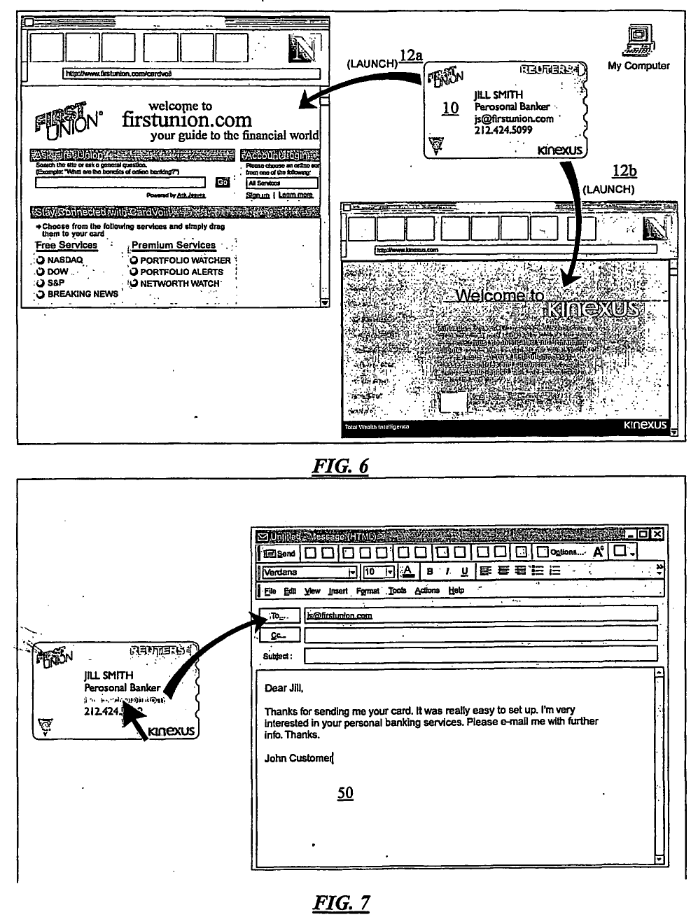

FIG. 6 illustrates an example graphical display showing an Envoii PIA providing active links to two different URLs through launched browser windows. In this example, on example PIA 10 are two links 12a and 12b that allow selection to URL locations. Likewise, a VP envoii can contain multiple links, for example one to a credit card accound and one to an associated frequent flier account. In further embodiments, a VP envoii could contain links to multiple accounts, such as to different credit accounts, different checking accounts, and/or different savings accounts.

FIG. 7 illustrates an example graphical display showing an Envoii PIA activating an associated function, such as an email sending program. In particular embodiments, virtually any application can be launched from an Envoii. For example, a VP envoii can contain links to an travel purchase site, a auction site, or other retail site and launching those sites from the VP will automatically activate the VP to pay for purchases made on those sites.

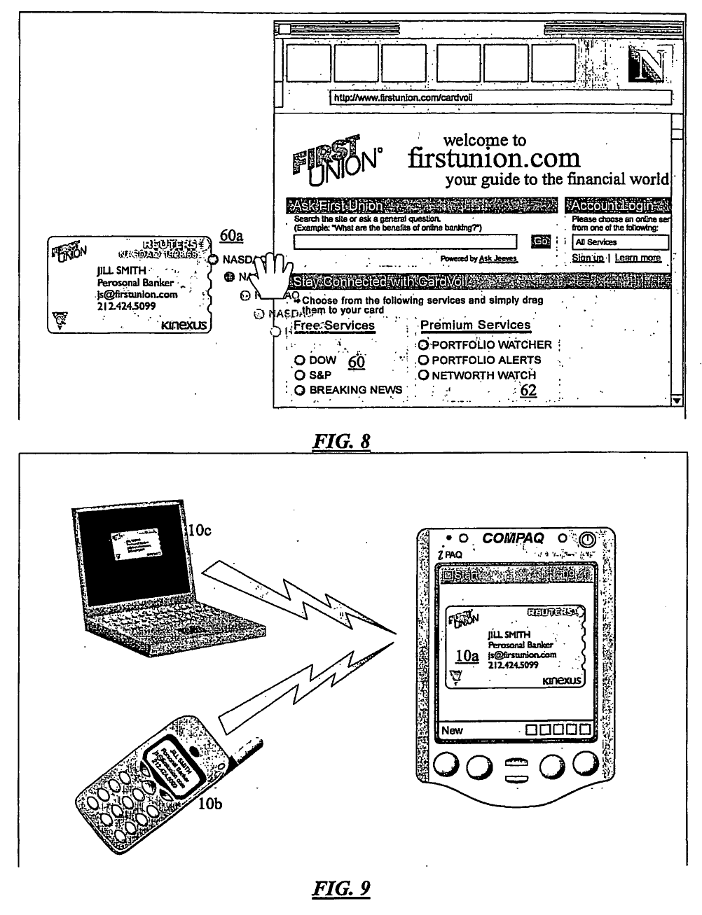

FIG. 8 illustrates an example graphical display showing an Envoii PIA being associated with a composable function. Thus, according to specific embodiments of the invention, Envoiis can become part of another Envoii and users can personalize their experience, configuring services as needed. Businesses can easily add or update services provided to Envoiis. An authoring environment, according to specific embodiments of the invention, allows new Envoiis to be “snapped together” for easy expandability. As shown in the figure, a user can select from a group of free services Envoiis 60 or premium service Envoiis 62. In this example, these Envoiis are represented as dots (such as 60a) with text indicating a service. When dragged to an appropriate Envoii PIA, the dots graphically snap into slots or groove on the business card Envoii 10. Once snapped in, the service Envoiis remain associated with the business card Envoii and is activated along with the business card Envoii. In the case of a VP envoii, for example, a service might be a telephone calling plan or a frequeny flyer plan, or a purchase rewards plan. Once linked, such plans can have charges handled by the VP envoii or have earned rewards credited to a VP envoii.

FIG. 9 illustrates an example graphical display showing an Envoii PIA moved to multiple information devices. According to specific embodiments of the invention, Envoiis, including VP envoiis, run on the most popular operating systems and can migrate seamlessly from platform to platform. Thus, content created in the Envoii authoring environment is targeted to live on any platform.

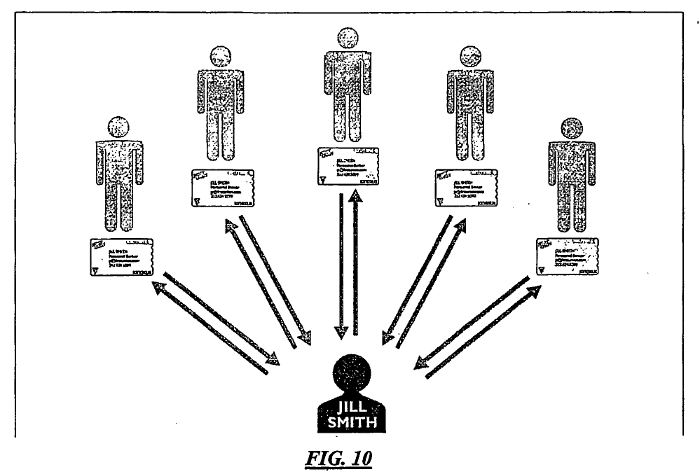

FIG. 10 illustrates an example business method according to specific embodiments of the invention wherein a services provider can keep in touch with multiple customers using an Envoii PIA. According to specific embodiments of the invention, the invention allows Multicast and Peer to Peer cornmunications. Persistent connections can be established between any two Envoiis wherever they are. Connections between Envoiis can be used for Instant Messaging, data exchange, file sharing and collaborations. For example, in this case Jill's clients might be able to share stock tips with one another.

What follows are summaries of still more detailed descriptions of example systems and methods that embody and/or enable in specific embodiments, various aspects of the present invention. More detailed descriptions of these novel example systems and features can be found in the above-referenced patent applications.

Architecture Enabling Envoiis According to Specific Embodiments of the Invention

In further embodiments, the invention comprises a distributed component architecture that facilitates methods discussed above. From the teachings provided herein, it will be understood that this is one example architecture and that other architectures are possible. This architecture can be understood as based on an aggregation model as opposed to an inheritance model. The design offers maximum flexibility and adaptability to environments that cannot always be predicted, without placing undue constraints on what is possible.

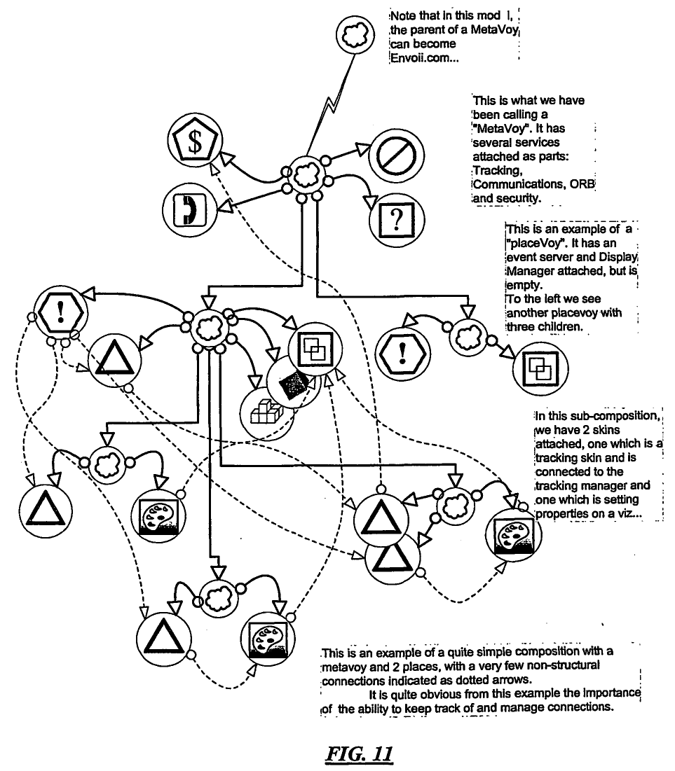

FIG. 11 illustrates an architecture of a component oriented system that can be used according to specific embodiments of the invention to enable an account access Envoii™ PIA. FIG. 12 is a diagram providing additional details regarding the architecture shown in FIG. 11. As will be seen from these figures, an example architecture according to specific embodiments of the invention, includes a number of different components in a connected architecture as further described below. In the model shown, a “MetaVoii” is an executable component that is generally transparent to an end-user and that allows Envoiis PIAs to operate. A MetaVoii 100 has several services attached as parts: Tracking, Communications, ORB and Security. The parent of a MetaVoii on a client machine can be a remote server MetaVoii 101, such as one located at Envoii.com. A PlaceVoii 110 allows an Envoii PIA to exist in a particular place, such as a browser window or a desktop. In FIG. 11 there are two PlaceVoiis, the one on the left has three children or “kid” connections 112. In this case, these are each connections to Envoiis 120 that have a visual component are a perceivable, such as a CreditCardVoii, a BusinessCardVoii, a BottleVoii, or a LogoVoii. In the indicated sub-composition 120c, there are 2 skins attached, for example a tracking skin connected to the tracking manager and a skin setting properties on a viz. The other indicated composition is an example of a quite simple composition with a MetaVoii and two places, with a very few non-structural connections indicated as dotted arrows.

In FIG. 12 is explained the various symbols used in the architecture illustrated in FIG. 11. An “Envoii,” as an instance of a class, provides generic graph interface. The connection points are representative of open set of “ports” which enable connections to other Envoiis. A “Kid” connection, which is a specialization of a “Part” connection, is the primary glue used by designers in building compositions. It effectively helps implement a tree-hierarchy as in the current system. Part connections are structural, and enforce a part/part-of protocol. A dynamic connection can be an transient connection or not. A skin or SkinVoii bears a part-of relationship to an Envoii. A viz bears a part-of relationship to an Envoii. A DisplayManager is a part of an Envoii which provides a rendering service. An “Event Service” is also indicated, as described below.

According to specific embodiments of the invention, the architecture can be understood as a node-based architecture, with a number of “Envoiis.” Envoiis, as described further herein, include active components that can be either MetaVoiis, PlaceVoiis, or Envoiis. Envoiis can be of various types, generally with various functionality and with particular and characteristic visual components. For example, a BusinessCardVoy is illustrated in FIG. 4 through FIG. 10. As shown in those figures and described above, the BusinessCardVoy has the appearance of a business card and connects to appropriate services. Other Envoiis can include such things as an advertising item (such as a soft-drink bottle that provides interesting user interactivity), a credit card, a representation of a globe, etc.

An example implementation of an interactive graphical object or agent (herein referred to as an Envoii) according to the invention provides the following services: (1) Envoiis, using built-in traversal capabilities, can perform service retrieval. This means one can ask an Envoii: “Find me service Foo” and the Envoii will return a reference to a service of type Foo, if one is available. In particular embodiments, service requests are propagated from child Envoiis up to parent Envoiis. In some embodiments, a top level parent will be an external server that provides a library or references to all available services. (2) Effectively, the semantics (real-world behaviors like rendering, animation, etc.) are implemented through Envoii services. (3) Envoiis provide support for an arbitrary number of connection points, referred to herein as “ports.” These ports can be named, and provide type signatures, etc., in the form of interface specifications. (4) Envoiis are constructed and added to a tree composition. (5) Envoiis are connected to one-another through the use of objects called “connections.” Connections are generally from port to port, and have explicit references to two ports. (6) Mechanisms are provided for search and traversal of Envoii hierarchy.

Generally, relations between Envoiis are based on the same connection mechanism. Interfaces—Each Envoii supports a set of interfaces identified with a unique interface ID. All Envoiis will inherit default Interfaces and add their own specific Interfaces. When a client Envoii wants to establish a connection to another Envoii's Interfaces, it needs to have a reference to that server Envoii. Either it already has that reference (for example because it structurally knows the server Envoii) or it will get the reference through the Service Discovery mechanism. Using that reference, the client Envoii will query the server Envoii to check that the Envoii actually supports the desired interface. At that point the communication between the Envoiis can be established. The communication is asymmetric in the sense that it has a client/server aspect. Symmetric communication can be established between two Envoiis by establishing two connections. The standard Interfaces include the Service Discovery support, symmetric communication protocols, etc.

Ports—Both ends of the communication are managed symmetrically by ports using a channel. Because an Envoii can have several connections to the same interface, each connection needs to have it's own port. In a sense, a port on the server side is an instantiation of the interface. The port on the client side it conceptually similar to a proxy.

Channel—The actual communication between the Envoiis will be encapsulated by the ports to travel through a communication channel. The channel is responsible for transporting the interface method calls and their parameters. It also transports direct communication between the ports themselves. The type of channel transport will depend on the relative location of the Envoiis (in process, inter process, remote). Envoii (or Enode) references are unique inside of their identification space.

PlaceVoiis

In particular embodiments, an architecture according to the invention further comprises PlaceVoiis and MetaVoiis as described below. PlaceVoiis can be understood as a type of Envoii that allows other Envoiis to operate in a particular place. A computer system that first encounters a graphical Envoii through a particular browser (such as Netscape Navigator™, for example), will receive a PlaceVoii allowing existence of that graphical Envoii within Navigator. If a user drags the graphical Envoii to a different application (or if the Envoii is triggered to move spontaneously), such as Internet Explorer™, for example, a different PlaceVoii will be invoked to enable existence within that different application. Likewise, if an Envoii is dragged onto a desktop, a PlaceVoii appropriate for that desktop (in the particular operating system) will be downloaded (if necessary) and invoked.

MetaVoiis

A MetaVoii is an Envoii that exists at the highest level within a user's particular operating system. It detects relocation of a graphical Envoii to a new location and triggers the downloading and invocation of necessary PlaceVoiis to allow existence in different locations. In particular embodiments, a MetaVoii can trigger the loading and invocation of other MetaVoiis for different platforms, such as when an Envoii is relocated from a desktop computer to a PDA or to a different desktop computer on a network.

In particular embodiments according to the present invention, a graphical Envoii always has an ancestor that is a PlaceVoii, and a PlaceVoii always has a parent that is a MetaVoii. A MetaVoii generally has a parent that is a remote authoritative server for providing available PlaceVoiis, services, or other architectural entities. Generally, MetaVoiis and PlaceVoiis will not be associated with graphical objects directly and will operate transparently to users.

Connections

According to specific embodiments of the present invention, a connection specifies a relationship between two Envoiis. In this context, an Envoii can be understood as both an agent with which a user interacts and as a node in the Envoii architecture that supports that agent and may be transparent to a user. Nodes in the architecture provide formalized connection points for various Envoiis and supporting infrastructure.

Special Connections Examples

There are several types of connections that are peculiar to an Envoii system, according to specific embodiments. (1) Part/Part-of Connection is the structural glue that holds together “compositions.” It is a directed connection that says, “B is part-of A.” The intention here is to provide a formal method for identifying what gets “dragged along” when an Envoii is disconnected from its parent. (2) Kid: The Kid or “Child-of” connection is a special case of the Part/Part-of connection. It will be used to implement hierarchy within Envoii compositions. (3) Special Part Envoiis: All structural connections to an Envoii that are not Kids or Parents are Parts which facilitates service search procedures.

Visuals (Viz)

A Viz is a visual part of an Envoii that is normally perceivable by a user. A Viz subscribes to services such as: (1) Display manager; (2) Spatial Manager.

SkinVoiis (or Skins)

A skin (or SkinVoii) is a part that subscribes to events (user or otherwise) and, in general, operates on the properties of compositions or visuals. A skin can be understood as executable logic that provides interface functions for one or more Envoiis. According to specific embodiments of the invention, because a skin is a part, there is no limit to the number of skins that can be associated with a viz through its connected Envoii. Some of the services that are provided internally as methods to skins in some implementations can also be factored out to. Focus management is one example. Those skins that are interested in “focus” will obtain and connect to a special service called a “Focus Manager”. (This is an example of a Skin that is also a service).

SkinVoiis are responsible for interactions between the user and the Envoiis as well as interaction between Envoiis. They implement the behavior of Envoiis. In that sense, they mostly translate events into property value changes. SkinVoiis are parts. As such, a SkinVoii is directly attached to an Envoii and does not have parts or kids. A SkinVoii interacts with the rest of the system through its parent Envoii (service connections, access to property tree, etc.) When an Envoii is serialized (persistence, cut and paste, etc.), its SkinVoiis are also automatically serialized.

Communication Done Through SkinVoii

According to specific embodiments of the present invention, the Envoii-to-Envoii communication model allows Envoiis to communicate even if they are not running in the same thread of execution (or even on the same machine). Because the software implementation according to specific embodiments of the invention is neither asynchronous nor re-entrant, communication between Envoiis needs to be synchronized by the event loop of the players. This means that messages between Envoiis should be carried by events, which indicates that communication between Envoiis has to be done through SkinVoiis. From the point of view of the SkinVoii, the communication manager is an auxiliary to the event manager which provides information that completes the communication event itself.

Services

According to specific embodiments of the invention, the Envoii architecture is associated with a number of functions referred to as services. Services can be nested. This is especially desirable in the case of the display service, and implicit in the spatial service. All of the functions of an Envoii player (as discussed herein) can be cast as services. Services need not be local. This happens without further effort if one follows the chain of Envoiis up past the MetaVoii level at the local machine to the server level MetaVoii. Example services that may be associated with Envoiis according to specific embodiments of the invention include such things as the Communication Manager, Display Manager, Events Manager, Focus Manager, Memory Management, Tracking Manager, and Security Manager. Not all of these services will be included in each implementation.

Communication Manager

The Communication manager allows a skin (or SkinVoii) to communicate with another skin. This skin can be located in the same PlaceVoii, in an other PlaceVoii within the same client or in a remote PlaceVoii. This section discusses the functionality implemented within the Communication Manager (ComMgr) component. The Communication manager (ComMgr) is instantiated at the level of the MetaVoii. In particular embodiments, it inherits from nvNode and is attached as a part of the MetaVoii. The ComMgr is not an Envoii, as it does not have any parent/child connection. The part mechanism allow each Envoii of a composition tree to access this service through the ConnectService method implemented in the nvNode interface. There will be an instance of ComMgr component for each instance of the MetaVoii within one client.

The communication manager allows skins to send and receive messages, with each message an instance of SkinMessage class. This class contain the message send between skin and routing/addressing information.

Push Server

A Push server provides content on demand for Envoiis that are push enabled; a push enabled Envoii has in its properties the address of a push server to which it connects periodically (the period can be defined in the Envoii) to check for updates. There can also be a push protocol, such that if the server has updates, it sends them to the Envoii for immediate refresh. For example, a softdrink bottle Envoii can carry an advertising message and subscribe to a push server for message updates. This and following Figures contain other elements of external communications that are not part of all embodiments.

Community Server

A Community server provides a way for Envoii users to find each other and communicate with each other. Napster or Icq are examples of community-based connections that are similar to Envoii community servers. This facility provides a powerful way for clients to do community marketing.

Tracking Manager

Tracking is the ability for a player to gather data about how the user interacts with Envoiis, and then to send this information through tracking servers. For example, tracking how many times the user has clicked on an Envoii in a certain period of time, how long he left his mouse above it, etc. Tracking is completely anonymous. That means the system never makes any link between the data collected and the machine or the person who originated that data. Also, there is only tracking of Envoii deployed objects, no information is collected on the end user.

This is the normal topology for tracking. Each player talks to three different servers: the Envoii server provides the Envoii components; the Customer server provides the content and customized components; and the Tracking server collects the tracking data for all players in the world. In these and other figures, communications with remote servers or players will be understood from the teachings provided herein to be over any available data communication channel, such as the world-wide Internet.

According to specific embodiments of the invention, a tracking system tracks events. It can use a special tracking SkinVoii that records specific events and forward them to a Tracking Manager at the player side. The Tracking Manager stores the data in a local file. Periodically, the Tracking Manager connects to the Tracking Server and sends reports.

Envoii Identity

For tracking information to be relevant, according to specific embodiments of the invention, the system provides a method for tracking the source Envoii. There are different possible levels of identification according to specific embodiments of the invention: (1) Envoii class level: for example, a graphical soft drink bottle Envoii. The system can track all clicks on all the bottle Envoiis in the world. (2) Envoii object level: e.g. to differentiate the clicks on two bottles living in the same place, for example a web page. (3) Player level: to differentiate a bottle on one user's desktop from a bottle on another user's desktop. (4) World level to identify a specific instance of a bottle Envoii throughout the world. To provide all these levels of identification, according to specific embodiments of the invention, a tracking system uses different kinds of IDs with different allocation methods. The way these IDs are allocated and propagated is linked to the Envoii life cycle, and Ids can be predefined properties with a special property type.

Player ID

To identify players throughout the world, according to specific embodiments of the invention, every player when installed registers with the Envoii server for a new Id. To do that, the invention delivers “virgin” players, i.e. players without an Id. During the first installation, the installer or bootstrap will try to connect to the Envoii server and request a new ID. An Envoii server holds a player ID database. If a player ID is not received at installation, the local system still collects tracking data. According to specific embodiments of the invention, player Ids can be stored with 4 bytes, which allows 2³² players in the world. A redirection mechanism on the server (e.g. in the CGI script) can be used to allow multiple servers, or to handle temporary server unavailability. The ID database can also count how many player Ids have been allocated per platform. On the end user machine, player Ids can be stored in different places, such as one of the player components (for example, the ORB (discussed herein) through a patch to DLLs). Ids may also be stored in the registry, though this location is liable to loss or modification by the user. Another option is the data directory, but this presents some of the same problems as the registry. According to specific embodiments of the invention, both in the registry and in the data directory is one choice.

Customer ID

According to specific embodiments of the invention, it is essential that Envoii customers (for Example, First Union Bank as described above) get tracking data on Envoiis deployed by those customers only. That means Envoiis must know to which customer they belong. According to specific embodiments of the invention, each customer has a customer ID (which can include a convenient number of bits, such as two bytes) and that id is stored by Envoii creation tools in the Envoii at compile time.

Class ID

According to specific embodiments of the invention, customers can differentiate tracking data for different types or classes of Envoiis (for example a bottle Envoii versus a logo Envoii). This is done using the Envoii Class ID. Envoii class Ids are allocated by the content creators that will keep track of the allocated Envoii class Ids.

Envoii local ID

The Envoii local ID is a local number inside a place. Envoiis of the same class ID and same customer ID have different local Ids in the same place (web page, desktop, etc). This ID can be set at compile time for objects that will be created when the composition is created. For dynamically created Envoiis, local Ids can be allocated automatically, or with the help of specific scripting functions.

Normal Envoii ID

Normally, Envoiis do not need unique identification throughout the world. So the normal ID is simply the combination customer ID: Envoii class ID: local ID. In one example embodiment, the total size is 6 bytes. When a normal Envoii is copied, the Envoii ID is copied and a new local ID is allocated. When a normal Envoii is moved (Cut & Paste), the Envoii ID is unchanged. This will happen in the Copy/Paste and Drag & Drop operations.

Global Envoii ID

According to specific embodiments of the present invention, a Global Envoiis can be created with a unique identification throughout the world. This is accomplished using UUIDs (similar to those used for C++ class Ids).

Other Components

Display Manager

Executable code that enables display of Viz in different locations. Generally, there is one DM for each PlaceVoii.

Events Manager

Can either be per platform or in some cases additional events managers can exist in various local nodes on the tree.

Focus Manager

Not all Envoiis and their attached skins care about focus. Those that do register with a skin that is a focus manager.

Memory Manager

In specific embodiments, this can happen in a nested way, so that Envoiis get their own local memory manager which requests a block of memory from its (parent) memory manager. A system may need to override C++ constructors to use this system to have a clean way of cleaning up after disconnecting an Envoii.

Namespace Management

This manager provides support for global referencing to various nodes or leaves in an Envoii component-oriented architecture. This is related to Envoii identity. Each Envoii is assigned a locally and/or globally unique identifier. This identifier is used for: (1) Tracking—a compact key for generating reports (2) Finding mobile Envoiis. Identifier is used by remote ORB as search key. Mobile Envoiis need to report place changes to ORB hierarchy. (3) PlaceVoiis will need to know that they are in a special kind of place, like a Mac or PC or PDA. The services they request will need to be instantiated on the basis of their “place identity.” PlaceVoiis ask for services like: “MacPlace.EventServer.”

Service Discovery In Envoii Architecture

When an Envoii is connected to its parent, or connected to any of its “grandparents”, it needs to discover and be wired up to a set of services, which will vary from Envoii to Envoii. One primary interface that Envoiis include is service discovery. In specific embodiments, the following method is used: (1) if you are an Envoii, ask your parts first, then ask your parent, (2) if you are a part, ask your Envoii. Thus requests for services flow upstream or laterally (to parts), but not downstream. This is the reason for the distinction between parts and kids. Because, according to specific embodiments of the present invention, services are nestable (multiple instance of the same service within the tree), the first service encountered is generally the one that is used, unless a particular service at a particular level is asked for by name (like: “../../eventService” or “foo.eventService”.

1. User Desktop Experience Example Implementation

According to specific embodiments of the present invention, the desktop experience in windows is based on two different modules: bootdesk and PlaceVoii. Bootdesk is a bootstrap (an executable) module that creates a transparent window to be used as a desktop PlaceVoii. Bootdesk can be started on its own, or it will be started automatically when an Envoii is dropped on the desktop. When bootdesk is running, an icon appears in the taskbar. According to specific embodiments of the present invention; a right click on that icon gives access to a menu with different options to control bootdesk.

Transparent window

Envoiis need a place to live. Basically, a place is a window. In a web browser, the window is provided by the browser. In the application bootstrap, the browser Envoii can be created in a regular window with a caption and a menu bar. For the desktop, according to specific embodiments of the present invention, a window is also needed, but in specific embodiments the window covers the whole screen, without obscuring the desktop. While one solution could be to use the desktop window itself, this does not work (under Windows) because one cannot subclass a window that was created in a different thread.

To meet this problem. the invention created a window that is made invisible and disabled in order not to disturb the desktop. If this window is created as a regular top-level window, there can be three problems: the window can be minimized automatically by the system, the window can appear above other applications, and a bootdesk application button will appear in the taskbar (at the bottom of the screen). To solve these problems, the window is created as a child of the program manager window, more precisely a child of the SysListView32 window (the window displaying the icons over the wallpaper).

Desktop PlaceVoii

How to draw in the created invisible and disabled window and how to handle the mouse inputs is the job of the desktop PlaceVoii. The desktop PlaceVoii uses the same subclassing technique as the plugin and the bootapp PlaceVoii. Subclassing of a window means that the original window procedure is replaced with a new procedure. The window procedure is a function called for every message received by the window. There are two major problems solved by this embodiment of the present invention. The first is how to draw Envoii objects on the desktop and have them move over it smoothly. The second is how to receive user inputs (mouse & keyboard) as well as repaint messages, given that the window is invisible.

CORBA Example Implementation—ORB (Object Request Broker)

According to specific embodiments of the present invention, the invention can be implemented using in part standards-based architectures and protocols for component-based programming. One such standard is known as CORBA (Common Object Request Broker Architecture), which has been developed by the 500+member Object Management Group (OMG). Another such standard is the Component Object Model (COM), developed by Microsoft. According to specific embodiments of the present invention, the invention can be implemented in either of these standards-based environments.

Further Example Implementation Details

Player and Player Installer

In order for Envoii PIAs to exist on a client system according to specific embodiments of the invention, an Envoii player is placed on the client machine to handle Envoii PIAs. The Player, according to specific embodiments of the present invention, is made of several elements, the active components of which are discussed in the applications referenced above.

Example Drag & Drop Implementation

According to specific embodiments of the invention, drag and drop is the ability provided to allow Envoii PIAs to be transported between “places” using an indication method, such as a pointing device such as a mouse. According to specific embodiments of the invention, a user can click on an Envoii, drag it on the screen while keeping the mouse button down, and finally release a pointer to drop the object somewhere else. The place where a user picks up an object is called the drop source. The place where a user drops the object is called the drop target. The object used between the drop source and the drop target is called the data object.

Typically, drop sources and targets are windows from one or more applications, though targest, especially, can be indications of other connected machines. Typically, applications involved in a drag and drop do not have to know each other. They can pass objects to each other provided they share some of the formats that these objects can take. These formats are usually called clipboard formats. There are some predefined formats for simple texts, bitmaps, files, GIFs, etc. When an object is dropped somewhere, if a user indicates to delete the original object, and this is called a move. If the original object is kept in place, it's called a copy. Move or Copy is called the drop effect. During the drag and drop operation, a user generally needs some feedback. For instance, he needs to know when dragging starts, or what object is being dragged. Also, when he moves his cursor over different windows, he needs to know which one is a potential drop target, and for which drop effect (copy or move). These operations must be performed by the drop source and the drop target. Also, the drop source and the potential drop targets need to know what is going on during the dragging. For instance, the drop source wants to know when the object is dropped, and with which drop effect. On the other side, the drop target needs to know which formats are available for the objects being dragged over him. Depending on the formats, he will or will not accept the drop.

To preserve a good interoperability between applications, as well as a coherent look and feel, the communication protocols between the drop source, the drop target and the data object, are usually defined by the system. For instance, drag and drop under Windows is done using OLE, which itself is based on COM. Applications implementing drag and drop often use system libraries.

Envoii Implementation of Drag&Drop

According to specific embodiments of the invention, because Envoiis perform cross-platform, the invention, rather than including its own drag and drop libraries wraps the system drag and drop features inside classes.

Composability.

According to specific embodiments of the present invention, the invention provides PIAs with a compositional model of content. This means that an Envoii web page, for example, is a hierarchical composition of various envoiis. The root of this hierarchy is the special envoii called PlaceVoii, because it represents a place that envoiis can exist. The children of this PlaceVoii are other envoiis.

Further, according to specific embodiments of the present invention, any envoii can dynamically become a child (part of) any other envoii. This capability is referred to herein as composability. Since each envoii in a composition is self-contained and autonomous, this enables a new model of software construction: (1) Users can personalize their experience and compose and aggregate useful envoiis in any configuration without loss of functionality. (2) Businesses can dynamically add new functionality, or upgrade old functionality in already deployed applications simply by sending new envoiis to their users. (3) Businesses can offer premium services, embodied as envoiis, to their users. Because of envoiis' built-in tracking capability, these services can be offered on an ASP or per-use basis. (4) Designers can rapidly develop new envoiis by “snapping together” already existing envoiis and customizing.

Embodiment in a Programmed Information Appliance

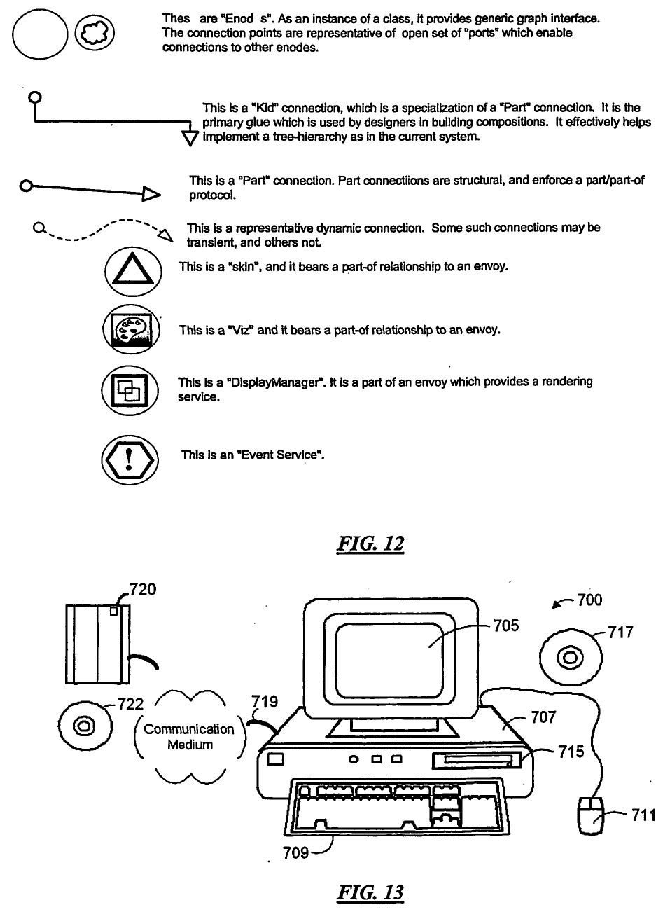

FIG. 13 is a block diagram showing a representative example logic device in which various aspects of the present invention may be embodied. As will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a viewer on a fixed media for physically loading into a viewer's computer or a fixed media containing logic instructions may reside on a remote server that a viewer accesses through a communication medium in order to download a program component.

FIG. 13 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of the invention. One type of logical apparatus that may embody the invention is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc. In specific embodiments, the invention may be embodied in whole or in part as software recorded on this fixed media. Communication port 719 may also be used to initially receive instructions that are used to program such a system and may represent any type of communication connection.

The invention also may be embodied in whole or in part within the circuitry of an application specific integrated circuit (ASIC) or a programmable logic device (PLD). In such a case, the invention may be embodied in a computer understandable descriptor language, which may be used to create an ASIC, or PLD that operates as herein described.

Other Embodiments

The invention has now been described with reference to specific embodiments. Other embodiments will be apparent to those of skill in the art. In particular, a viewer digital information appliance has generally been illustrated as a personal computer. However, the digital computing device is meant to be any information appliance for interacting with a remote data application, and could include such devices as a digitally enabled television, cell phone, personal digital assistant, etc.

In addition, channels have been described primarily as traditional network connections, with the appropriate corresponding hardware. However, channels are meant to be any channels capable of carrying data, including wireless channels, optical channels, and electrical channels.

It is understood that the examples and embodiments described herein are for illustrative purposes and that various modifications or changes in light thereof will be suggested by the teachings herein to persons skilled in the art and are to be included within the spirit and purview of this application and scope of the claims.

All publications, patents, and patent applications cited herein or filed with this application, including any references filed as part of an Information Disclosure Statement, are incorporated by reference in their entirety.

Conclusion

The invention has now been explained with regard to specific embodiments. Variations on these embodiments and other embodiments will be apparent to those of skill in the art. The invention therefore should not be limited except as provided in the attached claims. It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A method allowing a user to use an account to complete a transcation comprising:
providing a persistent graphical agent on a user device representing a credit/payment account;
registering a user action relating said persistent graphical agent with an item indication presented on a computer; and
in response to said action, said persistent graphical agent accesses necessary account data from local and/or remote storage and takes necessary actions to complete a transaction related to said item.

2. The method according to claim 1 further comprising:
after initiating said persistent graphical agent on a user device, registering a user relocation of said persistent graphical agent to a new location outside of an initial application that displayed said persistent graphical agent;
moving said persistent graphical agent to said new location;
preserving state of said persistent graphical agent; and
preserving communication links of said persistent graphical agent.

3. The method according to claim 1 wherein said persistent graphical agent has state and has one or more possible external communication links.

4. The method according to claim 1 wherein said persistent graphical agent, once relocated, will persist and maintain state after termination of said initial application.

5. The method according to claim 2 wherein said initial application is a web browser.

6. The method according to claim 1 wherein said allowing a user to perform an action comprises allowing a user to select said agent and swipe said agent over an item indication.

7. The method according to claim 1 wherein said allowing a user to perform an action comprises allowing a user to select an item indication and drag and drop said item indication over said agent.

8. The method according to claim 1 wherein said agent graphically resembles a credit/debit card and is linked to a credit/debit account.

9. The method according to claim 1 wherein said agent graphically resembles a check and is linked to a checking account.

10. The method according to claim 2 wherein said initial application is an email client.

11. The method according to claim 2 wherein said new location is a desktop provided by an operating system.

12. The method according to claim 2 wherein said relocation may be repeated from a current location to any number of additional platforms.

13. The method according to claim 11 wherein said desktop provided by an operating system is an interface of a platform, said platform selected from the group consisting of: a windows PC, a Macintosh PC, a unix-type operating system, a set-top box, a wireless logic appliance, internet appliance, a personal digital assistant, or any other information device connected to a network.

14. The method according to claim 2 wherein said new location is selected from the group consisting of: a desktop providing by an operating system; a different application: a different computer platform with a different operating system.

15. The method according to claim 1 wherein said graphical agent includes one or more user interface components and wherein said components are preserved after a relocation.

16. The method according to claim 1 wherein said graphical agent includes one or more connections to one or more external entities and wherein said connections are preserved after a relocation.

17. The method according to claim 1 wherein said allowing a user to indicate relocation comprises selecting and dragging a persistent graphical agent.

18. The method according to claim 1 wherein said allowing a user to indicate relocation comprises discontinuously selecting a persistent graphical agent and placing said persistent graphical agent in a new location.

19. The method according to claim 16 wherein said one or more external entities are selected from the group consisting of: web servers, other applications, background processes, local storage, remote storage, and remote processes.

20. A method of placing an order for an item comprising:
at a client system,
presenting a persistent graphical agent;
presenting information identifying one or more items available for purhcase; and
in response to a user selection of said persistent graphical agent, activating said persistent graphical agent to transmit data to a server system to complete a transaction;
under control of one or more components of the server system,
receiving account data from said persistent graphical agent;
returning confirmation of a purchase to said client system.

21. A persistent agent system allowing a user to access one or more accounts comprising:
a presentation component for presenting a perceivable representation of said agent to a user;
a persistance module locally resident on a user device and allowing said agent to be moved between applications while preserving state and/or connections;
one or more persistent connections allowing said agent to communicate with one or more remote systems; and
user interaction logic specifying how said agent will interact with a user.

22. A system enabling a persistent graphical agent linked to one or more credit accounts comprising:
means for presenting a representation of said agent to a user;
means for registering a user action upon said agent;
means for allowing said agent to be moved from an initial location to a new location while preserving state and connections; and
means for communicating between said agent and one or more remote entities that persist when said agent is moved to a new location.
